(19) United States
(12) Patent Application Publication
(10) Pub. No.: US 2024/0168751 A1
(43) Pub. Date: May 23, 2024

(54) ESTIMATING TEMPORAL OCCURRENCE OF A BINARY STATE CHANGE

(71) Applicant: Adobe Inc., San Jose, CA (US)

(72) Inventors: Luwan Zhang, Sunnyvale, CA (US); Zhenyu Yan, Cupertino, CA (US); Jun He, Fremont, CA (US); Hsiang-yu Yang, Palo Alto, CA (US); Cheng Zhong, Kearny, NJ (US)

(73) Assignee: Adobe Inc., San Jose, CA (US)

(21) Appl. No.: 17/989,362

(22) Filed: Nov. 17, 2022

(51) Int. Cl. G06F 8/656; G06N 20/00

(52) U.S. Cl. CPC G06F 8/656; G06N 20/00

(57) ABSTRACT

In implementations of systems for estimating temporal occurrence of a binary state change, a computing device implements an occurrence system to compute a posterior probability distribution for temporal occurrences of binary state changes associated with client computing devices included in a group of client computing devices. The occurrence system determines probabilities of a binary state change associated with a client computing device included in the group of client computing devices based on the posterior probability distribution, and the probabilities correspond to future periods of time. A future period of time is identified based on a probability of the binary state change associated with the client computing device. The occurrence system generates a communication based on a communications protocol for transmission to the client computing device via a network at a period of time that correspond to the future period of time.

### BACKGROUND

A binary state change associated with a computing device refers to a type of change which either occurs or does not occur during a fixed period of time such as an hour, a day, a week, etc. For example, a resource of a cloud-based service is either dedicated for use by the computing device during a fixed period of time or the resource is not dedicated for use by the computing device during the fixed period of time. In some examples, the binary state change associated with the computing device is related to a communication transmitted to the computing device (e.g., via a network) which facilitates an occurrence of the binary state change. For instance, the communication includes functionality usable to cause the virtual machine to be dedicated for use by the computing device (e.g., via a secure link that is available during the fixed period of time).

### SUMMARY

Techniques and systems for estimating temporal occurrence of a binary state change are described. In an example, a computing device implements an occurrence system to compute a posterior probability distribution for temporal occurrences of binary state changes associated with client computing devices included in a group of client computing devices using a machine learning model. The occurrence system determines probabilities of a binary state change associated with a client computing device included in the group of client computing devices using the machine learning model based on the posterior probability distribution.

For example, the probabilities correspond to future periods of time. A future period of time is identified based on a probability of the binary state change associated with the client computing device. The occurrence system generates a communication based on a communications protocol for transmission to the client computing device via a network at a period of time that corresponds to the future period of time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for estimating temporal occurrence of a binary state change as described herein.

FIG. 2 depicts a system in an example implementation showing operation of an occurrence module for estimating temporal occurrence of a binary state change.

FIG. 3 illustrates a representation of state change data.

FIG. 4 illustrates a representation of a first machine learning model and a second machine learning model.

FIG. 5 illustrates a representation of temporal occurrences of binary state changes estimated using a first model and a second model.

FIG. 6 is a flow diagram depicting a procedure in an example implementation in which a future period of time is identified based on a probability of a binary state change associated with a client computing device, and a communication is generated for transmission to the client computing device at a period of time that corresponds to the future period of time.

FIG. 7 is a flow diagram depicting a procedure in an example implementation in which a future period of time is determined based on a probability of a binary state change associated with a group of client computing devices, and a communication is transmitted to a client computing device at a period of time that corresponds to the future period of time.

FIG. 8 illustrates a representation of improvements of systems for estimating temporal occurrence of a binary state change relative to conventional systems.

FIG. 9 illustrates an example system that includes an example computing device that is representative of one or more computing systems and/or devices for implementing the various techniques described herein.

### DETAILED DESCRIPTION

### Overview

Binary state changes associated with client computing devices are types of changes which either occur or do not occur during a defined period of time such as a day, a week, a month, etc. During the defined period of time, for example, an amount of cloud-based resources allocated for use by a client computing device is either exceeded or not exceeded. By estimating temporal occurrence probabilities of the binary state change associated with the client computing device, it is possible to intervene in a manner which increases or decreases a likelihood that the binary state change actually occurs, e.g., by increasing the allocated amount of the cloud-based resources before a period of time associated with a highest probability of exceeding the allocated amount. Conventional systems for estimating temporal occurrence of a binary state change such as Thompson sampling are associated with relatively high per period regret. Because of this, interventions based on probabilities estimated using these conventional systems are unlikely to increase or decrease a likelihood that the binary state change actually occurs.

In order to overcome these limitations, techniques and systems for estimating temporal occurrence of a binary state change are described. In an example, a computing device implements an occurrence system to receive state change data describing historic temporal occurrences of binary state changes associated with client computing devices connected to a network. The occurrence system trains a machine learning model on the state change data to estimate temporal occurrences of binary state changes associated with the client computing devices.

In a first example, the machine learning model is a Bayesian mixture multi-armed bandit model. In the first example, the occurrence system implements the machine learning model to estimate temporal occurrence probabilities of the binary state change associated with groups of the client computing devices. The occurrence system also implements the machine learning model to estimate probabilities of membership in the groups for individual client computing devices. For example, the occurrence system identifies a client computing device included in a group of the client computing devices based on a group membership probability. A future period of time is determined based on a probability of the binary state change associate with the group. In an example, the occurrence system transmits a communication to the client computing device, via the network, at a period of time that corresponds to the future period of time.

In a second example, the machine learning model is a Bayesian Model-Agnostic Meta-Learning model. In this second example, the occurrence system implements the machine learning model to compute a posterior probability distribution for temporal occurrences of binary state changes associated with all client computing devices included in a group of client computing devices connected to the network. For example, probabilities of a binary state change associated with a client computing device included in the group of client computing devices are determined based on the posterior probability distribution. In this example, the probabilities correspond to future periods of time. The occurrence system identifies a future period of time based on a probability of the binary state change associated with the client computing device. A communication is generated for transmission to the client computing device, via the network, at a period of time that corresponds to the future period of time.

By estimating temporal occurrence of a binary state change in this way, the described systems are capable of intervention in a manner that increases or decreases a likelihood that the binary state change actually occurs. This is not possible using conventional systems which are associated with relatively high per period regret. This improvement is verified in results of performance evaluations which indicate that the described systems achieve significantly lower per period regret than conventional systems implements using Thompson sampling and an Epsilon Greedy algorithm.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

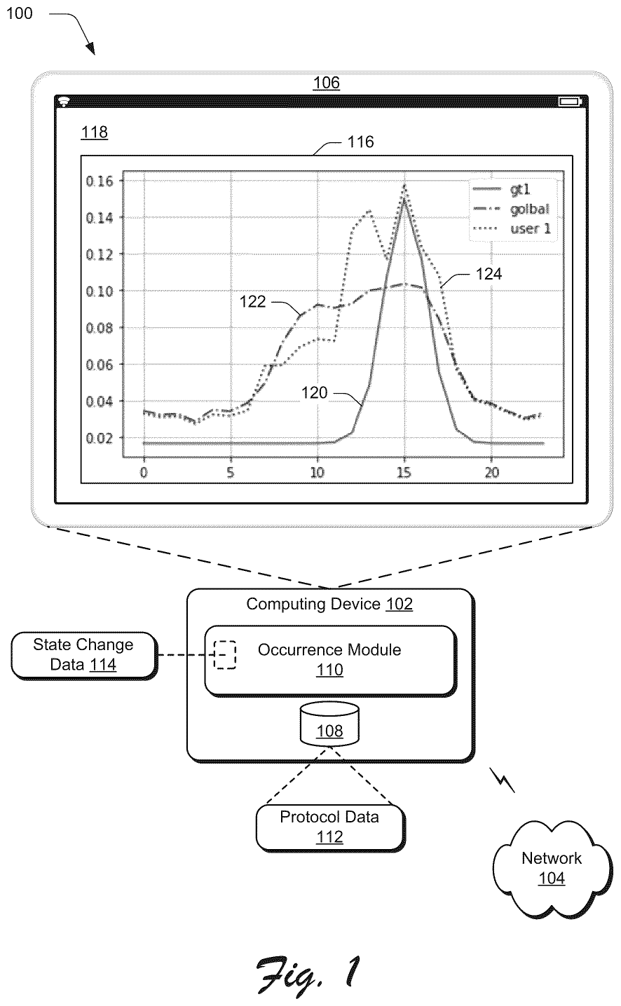

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. The computing device 102 includes a storage device 108 and an occurrence module 110. The storage device 108 is illustrated to include protocol data 112 which describes a communications protocol for generating and transmitting communications to client computing devices via the network 104, e.g., based on estimated probabilities of temporal occurrences of binary state changes associated with the client computing devices.

The occurrence module 110 is illustrated as having, receiving, and/or transmitting state change data 114. In an example, the state change data 114 describes historic temporal occurrences of binary state changes associated with client computing devices connected to the network 104. Examples of communications generated based on the protocol data 112 and possible corresponding binary states associated with the client computing devices include a communication that describes an available update to software of the client computing devices and binary states of either updated or not updated; a communication describing an invitation to join a virtual meeting and binary states of either joined or not joined; and a communication describing an electronic document to be reviewed and binary states of either reviewed or not reviewed.

Consider an example in which the occurrence module 110 trains a machine learning model on the state change data 114 (e.g., as training data) to estimate temporal occurrences of binary state changes associated with the client computing devices connected to the network 104. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In a first example, the occurrence module 110 trains a Bayesian mixture multi-armed bandit model on the state change data 114 to estimate temporal occurrences of binary state changes associated with the client computing devices connected to the network 104. In this first example, arms d of the Bayesian mixture multi-armed bandit model represent periods of time (e.g., hours of a day). The Bayesian mixture multi-armed bandit model leverages exploration (e.g., gaining new information) and exploitation (e.g., optimizing decisions based on existing information) to optimize an objective (e.g., accurately estimating temporal occurrences of binary state changes associated with the client computing devices) over multiple iterations of an experiment.

For example, in each iteration, the Bayesian mixture multi-armed bandit model selects an arm d based on the exploration/exploitation and observes a response X. Before an iteration, the Bayesian mixture multi-armed bandit model represents an unknown parameter Θ as a random variable having a prior distribution. This prior distribution represents a prior belief about a value of the unknown parameter Θ.

For instance, the observed response X also has a distribution, and a conditional distribution of the unknown parameter Θ given the observed response X is a posterior distribution. The posterior distribution represents information about the unknown parameter Θ after observing the response X. The Bayesian mixture multi-armed bandit model also includes additional learnable parameters which are updated based on the observed response X in each iteration such that the posterior distribution approaches a target distribution (e.g., the temporal occurrences of binary state changes associated with the client computing devices).

In a second example, the occurrence module 110 trains a Bayesian Model-Agnostic Meta-Learning model on the state change data 114 to estimate temporal occurrences of binary state changes associated with the client computing devices connected to the network 104. For example, the occurrence module 110 trains the Bayesian Model-Agnostic Meta-Learning model using Stein Variation Gradient Descent on a learnable parameter set that includes two levels of expressions—a global representation of all the client computing devices connected to the network 104 and an individual representation of each client computing device connected to the network 104. In one example, a nested hierarchy is utilized for this model that includes an outer loop that optimizes over all the client computing devices connected to the network 104 and an inner loop that fits data to each client computing device connected to the network 104 which initializes from the outer loop. For example, a loss associated with the data fit by the inner loop is backpropagated to the outer loop.

Once trained, the occurrence module 110 implements the Bayesian Model-Agnostic Meta-Learning model (or the Bayesian mixture multi-armed bandit model) to compute a posterior probability distribution for temporal occurrences of binary state changes associated with the client computing devices. For example, the occurrence module 110 uses the posterior probability distribution to generate an indication 116 which is displayed in a user interface 118 of the display device 106. As shown, the indication 116 depicts ground truth probabilities 120 of binary state changes associated with the client computing devices connected to the network 104 during a day, estimated global probabilities 122 of binary state changes associated with all the client computing devices connected to the network 104 during the day, and estimated individual probabilities 124 of a binary state change associated with a client computing device connected to the network 104 during the day.

For instance, the occurrence module 110 leverages the protocol data 112 and the estimated individual probabilities 124 to identify a period of time during the day (e.g., a future period of time) for transmitting a communication to the client computing device. In an example in which the communications protocol described by protocol data 112 indicates that it is undesirable for the binary state change associated with the client computing device to occur, the occurrence module 110 identifies the period of time during the day as having a relatively low probability of occurrence for the binary state change (e.g., an hour in a range of 0 to 5 hours or an hour in a range of 20 to 23 hours). In another example in which the communications protocol indicates that it is desirable for the binary state change associated with the client computing device to occur, the occurrence module 110 identifies the period of time during the day as having a relatively high probability of occurrence for the binary state change (e.g., hour 15). Accordingly, in these examples, by determining when to transmit the communication to the client computing device, the occurrence module 110 is capable of increasing or decreasing a probability of causing the binary state change associated with the client computing device.

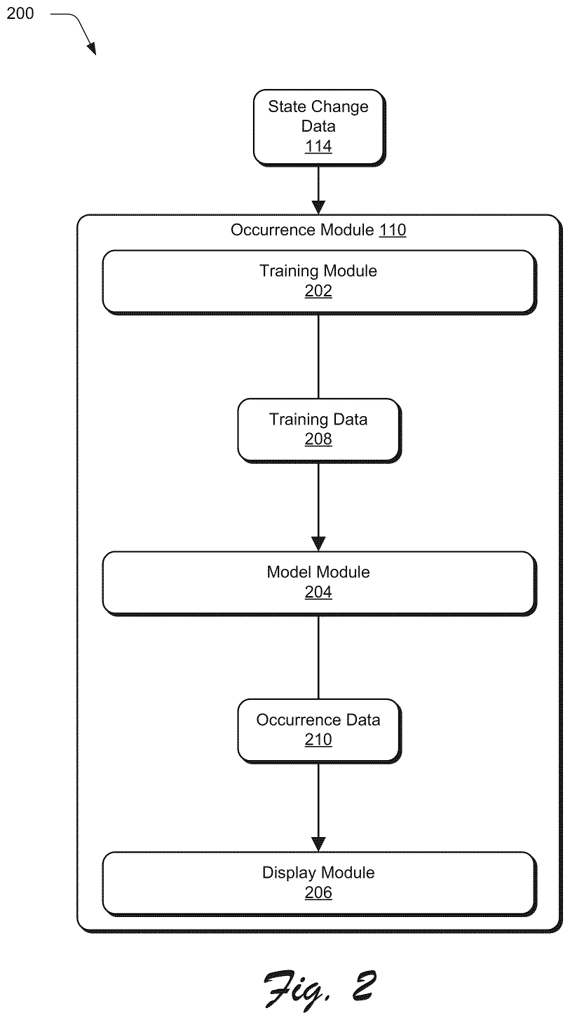

FIG. 2 depicts a system 200 in an example implementation showing operation of an occurrence module 110. The occurrence module 110 is illustrated to include a training module 202, a model module 204, and a display module 206. For example, the training module 202 receives and processes the state change data 114 to generate training data 208.

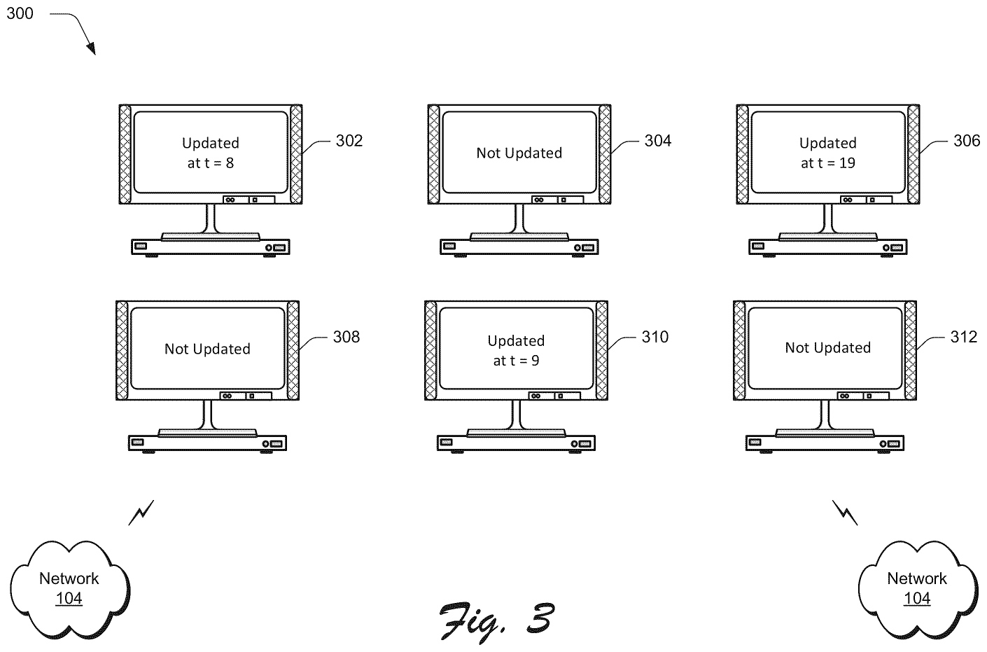

FIG. 3 illustrates a representation 300 of state change data. As shown, the representation 300 includes client computing devices 302-312 connected to the network 104 and indications of historic temporal occurrences of binary state changes associated with the client computing devices 302-312. In the illustrated example, the historic temporal occurrences of binary state changes associated with the client computing devices 302-312 are based on a communication transmitted to the client computing devices 302-312 via the network 104 describing an available update to an application of the client computing devices 302-312.

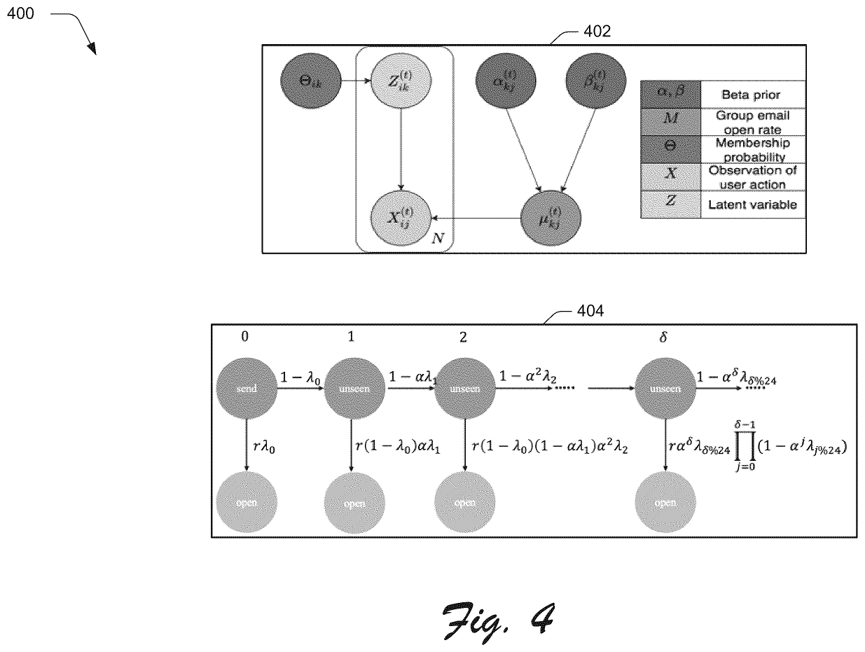

In this example, a historic temporal occurrence of a binary state change associated with client computing device 302 is “Updated at t=8;” a historic binary state associated with client computing device 304 is “Not Updated;” a historic temporal occurrence of a binary state change associated with client computing device 306 is “Updated at t=19;” a historic binary state associated with client computing device 308 is “Not Updated;” a historic temporal occurrence of a binary state change associated with client computing device 310 is “Updated at t=9;” and a historic binary state associated with client computing device 308 is “Not Updated.” The training module 202 receives and processes the state change data 114 describing the historic binary state associated with the client computing devices 304, 308, 312 and the historic temporal occurrences of the binary state change associated with the client computing devices 302, 306, 310 to generate the training data 208. FIG. 4 illustrates a representation 400 of a first machine learning model 402 and a second machine learning model 404.

For example, the model module 204 includes the first machine learning model 402 and the second machine learning model 404, and the training module 202 generates the training data 208 in a first manner for training the first machine learning model 402. In this example, the training module 202 generates the training data 208 in a second manner for training the second machine learning model 404. For instance, the first machine learning model 402 includes the Bayesian mixture multi-armed bandit model and the second machine learning model 404 includes the Bayesian Model-Agnostic Meta-Learning model.

In an example, a workflow of the first machine learning model 402 is representable as:

```
Given K, d, T, Θ, initialize {Beta(αₖⱼ⁽⁰⁾,βₖⱼ⁽⁰⁾}_{k∈[K],j∈[d]}, Φ
while t < T do
  t ← t + 1
  draw μₖⱼ^{(t)}~Beta(αₖⱼ^{(t-1)}, βₖⱼ^{(t-1)}) independently
  P^{(t)} ← M^{(t)}Θ
  for i ∈ [n] do
    aᵢ^{(t)} := argmax_{j∈[d]}pᵢⱼ^{(t)}
    collect response xᵢ^{(t)}~Bernoulli(pᵢₐ_{ᵢ}_{^{(t)}})
  end for
  for l < iters do
    (M − step) update \hat{M}^{(t)}
    (E − step) update θᵢₖ^{(t)}
  end for
  update αₖⱼ^{(t)} and βₖⱼ^{(t)}
end while
Return \hat{M}^{(T)} and \hat{Θ}^{(T)}
```

where: n represents a total number of client computing devices; K represents a total number of groups; d represents a total number of arms; T represents a total number of iterations; Θ={θᵢₖ}_{{i=1, . . . , N}}^{{k=1, . . . , K}} is a group membership probability matrix, θᵢₖ is a probability that client computing device i belongs to group k; M={μₖⱼ}_{{k=1, . . . , N}}^{{j=1, . . . , K}} is a group probability of occurrence of a binary state change; Prior distribution, Beta(αₖⱼ, βₖⱼ) s.t. μₖⱼ˜Beta(αₖⱼ, βₖⱼ);
P: individual client computing device probability of occurrence of a binary state change with [symbol] (P)=ΘM; latent variable Z={Zᵢₖ}_{{i=1, . . . , n}}^{{k=1, . . . , K}}˜Bernoulli(Θ={θᵢₖ}_{{i=1, . . . , n}}^{{k=1, . . . , K}}), zᵢₖ is a one-hot vector that indicates client computing device i's membership; and observed variable X^{(t)}={xᵢⱼ^{(t)}}_{{i=1, . . . , n}}^{{j=1, . . . , d}}˜Bernoulli (P={pᵢⱼ}_{{i=1, . . . , n}}^{{j=1, . . . , d}}, xᵢⱼ^{(t)} is client computing device i's response at arm j at round t.

In the above example, input parameters (e.g., hyperparameters) for the Bayesian mixture multi-armed bandit model include n, K, d, and T. The total number of the client computing devices 302-312 is n=6 and the total number of arms is d=24 which each represent one hour of a 24-hour day. In this example, the total number of groups is K=4 which includes one group for the client computing device 302, one group for the client computing device 306, one group for the client computing device 310, and one group for the client computing devices 304, 308, 312. In other examples, however, it is possible that the client computing device 302 and the client computing device 310 are included in a same group.

For example, learnable parameters for the first machine learning model 402 include the group membership probability matrix Θ, the group probability of occurrence of a binary state change M, the Prior distribution, and the individual client computing device probability of occurrence of a binary state change P. Variables for the Bayesian mixture multi-armed bandit model include the latent variable Z and the observed variable X^{(t)}. In some examples, the training module 202 generates the training data 208 for the first machine learning model 402 in iterations or rounds t.

In these examples, at each round t after initialization, a sample is drawn to get the group probability of occurrence of a binary state change M from a Bayesian posterior distribution estimated in a previous round t which promotes exploration. The group probability of occurrence of a binary state change M is then populated to the individual client computing device probability of occurrence of a binary state change P. For instance, a best arm d is calculated and a corresponding response X^{(t)} is collected. All responses X^{(t)} are aggregated and all learnable parameters are updated using an expectation-maximization algorithm which promotes exploitation. In one example, the training module 202 trains the first machine learning model 402 as part of generating the training data 208. In this example, training the first machine learning model 402 includes maintaining a group feature store and a membership store which are updated in each round t based on the expectation-maximization algorithm.

For the second machine learning model 404, the training module 202 generates the training data 208 under a survival regime to represent a time decaying effect on probabilities of occurrence of a binary state change. In an example, the Bayesian Model-Agnostic Meta-Learning model meta-learns a posterior probability distribution for temporal occurrences of binary state changes associated with all of the client computing devices 302-312 included in the representation 300 followed by transferring this to individual ones of the client computing devices 302-312 based on a relatively limited amount of data. Consider an example in which the communication is transmitted to the client computing devices 302-312 via the network 104 describing the available update to the application of the client computing devices 302-312 at an initial period of time. Following the initial period of time, probabilities of a binary state change associated with the client computing devices 302-312 decrease as new communications are received that suppress the communication transmitted at the initial period of time.

Given that the hours of the day range from 0 to 23, [λ₀, λ₁, . . . , λ₂₃] are utilized to represent a periodic basis for the occurrence probability at each hour of the day. The actual probability of occurrence at time lag δ is parameterized as α^{δ}λ_{δ% 24} where δ%24 is adopted to recall a corresponding basis and a is used to manifest a time decaying factor which is applied to probabilities of occurrence of the binary state change. For example, the binary state change is a Bernoulli event with a constant success rate r. In this example, the training module 202 generates the training data 208 as describing the occurrences of the binary state change associated with the client computing devices 302, 306, 310 which marginalizes a nuisance parameter for the second machine learning model 404.

Consider an example in which the training module 202 trains the Bayesian Model-Agnostic Meta-Learning model on an optimization objective which maximizes the posterior probability distribution based on a conditional log-likelihood and a prior. In this example, in order to overcome the resulting complex form, variation inference is utilized. Rather than directly working on [λ₀, λ₁, . . . , λ₂₃] and α, these are transformed into a logit space to leverage Stein Variational Gradient Descent which includes a deterministic update rule for optimization. For example, a learnable parameter set is representable as:

$$\\ Θ = [ {θ}_{0} , {θ}_{1} , … , {θ}_{23} , {θ}_{24} ]$$

$$\\ {θ}_{j} = log ( \frac{{λ}_{j}}{1 - {λ}_{j}} ) , j = 0 , … 23$$

$$\\ {θ}_{24} = log ( \frac{α}{1 - α} )$$

The above parameter set includes two levels of expressions, where Θ^{meta} refers to a global representation corresponding to all the client computing devices 302-312 and Θ^{ind} refers to an individualized adaptation. As a result, the optimization has a nested hierarchy in which an outer loop optimizes over all client computing devices 302-312, and an inner loop only fits individualized data initializing from the outer loop with a loss being backpropagated to the outer loop.

After the second machine learning model 404 is trained on the training data 208, the model module 204 receives a posterior distribution on Θ^{meta} from the trained model (e.g., pre-trained), and learns individual adaptations Θ^{ind} based on their own most recent data using Stein Variational Gradient Descent. For each hour of the day, a cumulative propensity score is computed based on a probability of temporal occurrence of the binary state changes associated with the client computing devices 302-312, and a future period of time is identified as having a highest score. After the first machine learning model 402 is trained on the training data 208, the model module 204 implements the first machine learning model to return \hat{M}^{(T)} and \hat{Θ}^{(T)} to identify the future period of time.

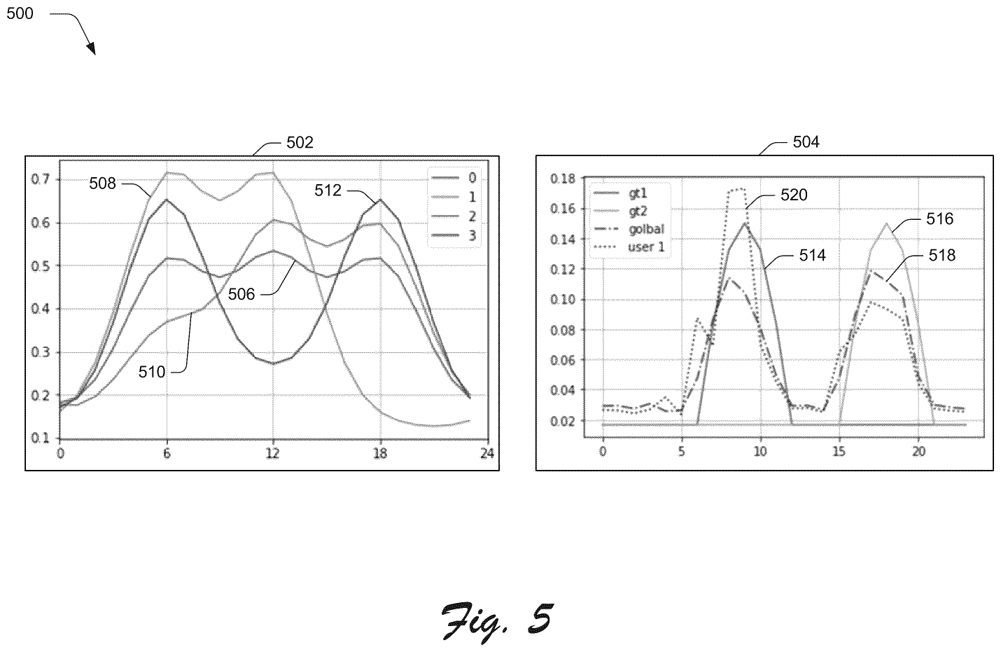

FIG. 5 illustrates a representation 500 of temporal occurrences of binary state changes estimated using a first model and a second model. For example, estimates 502 are generated using the first machine learning model 402 and estimates 504 are generated using the second machine learning model 404. As shown, the estimates 502 include probabilities 506-512 of binary state changes for each of the four groups at future periods of time during a day. For instance, probabilities 506 are for the group that includes the client computing devices 304, 308, 312; probabilities 508 are for the group that includes the client computing device 302; probabilities 510 are for the group that includes the client computing device 306; and probabilities 512 are for the group that includes the client computing device 310.

The estimates 504 include first ground truth probabilities 514 of occurrences of binary state changes and second ground truth probabilities 516 of occurrences of binary state changes. The estimates 504 also include estimated global probabilities 518 of binary state changes associated with all the client computing devices 302-312 included in the representation 300 and estimated individual probabilities 520 of a binary change associated with a client computing device (e.g., the client computing device 302) included in the client computing devices 302-312 at future periods of time during a day. For example, the historic temporal occurrence of the binary state change associated with the client computing device 302 is “Updated at t=8” and the estimated individual probabilities 520 of a binary state change associated with the client computing device 302 peaks at hour 8 of the day with an estimated probability of about 0.17.

The model module 204 generates occurrence data 210 describing the estimates 502 and the estimates 504. In an example, the display module 206 receives and processes the occurrence data 210 and the protocol data 112 describing the communications protocol to identify a future period of time for transmitting a communication to the client computing device 302 which describes an available update to an application of the client computing device 302. In this example, the display module 206 identifies a future period of time as hour 6 of the day based on the probabilities 508 and identifies a future period of time as hour 8 of the day based on the estimated individual probabilities 520. The display module 206 generates a communication based on the communications protocol for transmission to the client computing device 302 at a period of time that corresponds to the future period of time.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

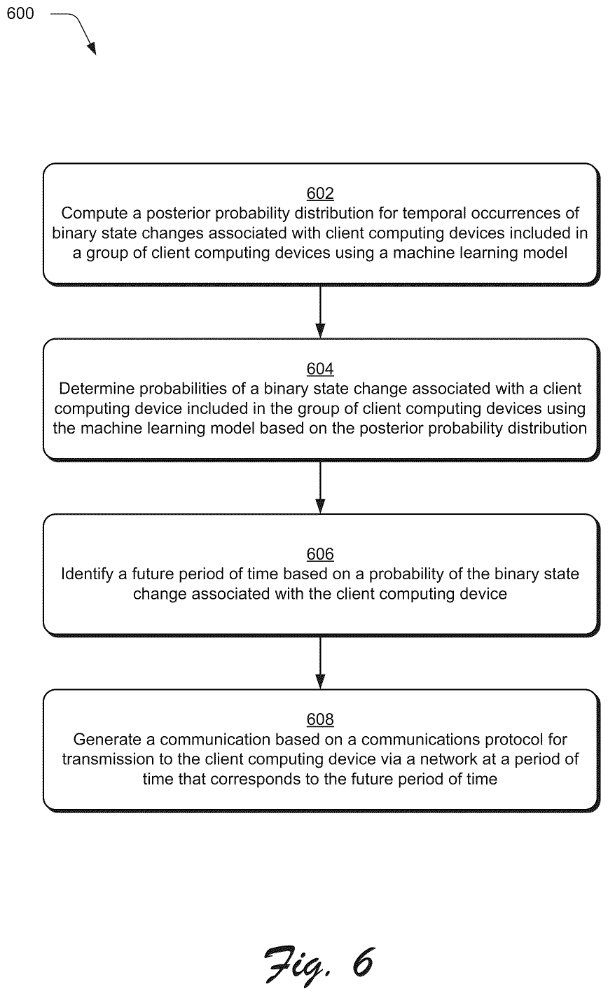

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5. FIG. 6 is a flow diagram depicting a procedure 600 in an example implementation in which a future period of time is identified based on a probability of a binary state change associated with a client computing device, and a communication is generated for transmission to the client computing device at a period of time that corresponds to the future period of time.

A posterior probability distribution is computed for temporal occurrences of binary state changes associated with client computing devices included in a group of client computing devices using a machine learning model (block 602). For example, the computing device 102 implements the occurrence module 110 to compute the posterior probability distribution. In one example, the occurrence module 110 computes the posterior probability distribution using the second machine learning model 404. Probabilities of a binary state change associated with a client computing device included in the group of client computing devices are determined using the machine learning model based on the posterior probability distribution (block 604). In some examples, the occurrence module 110 determines the probabilities of the binary state change associated with the client computing device.

A future period of time is identified based on a probability of the binary state change associated with the client computing device (block 606). In an example, the computing device 102 implements the occurrence module 110 to identify the future period of time. A communication is generated based on a communications protocol for transmission to the client computing device via a network at a period of time that corresponds to the future period of time (block 608). For example, the occurrence module 110 generates the communication based on the communications protocol.

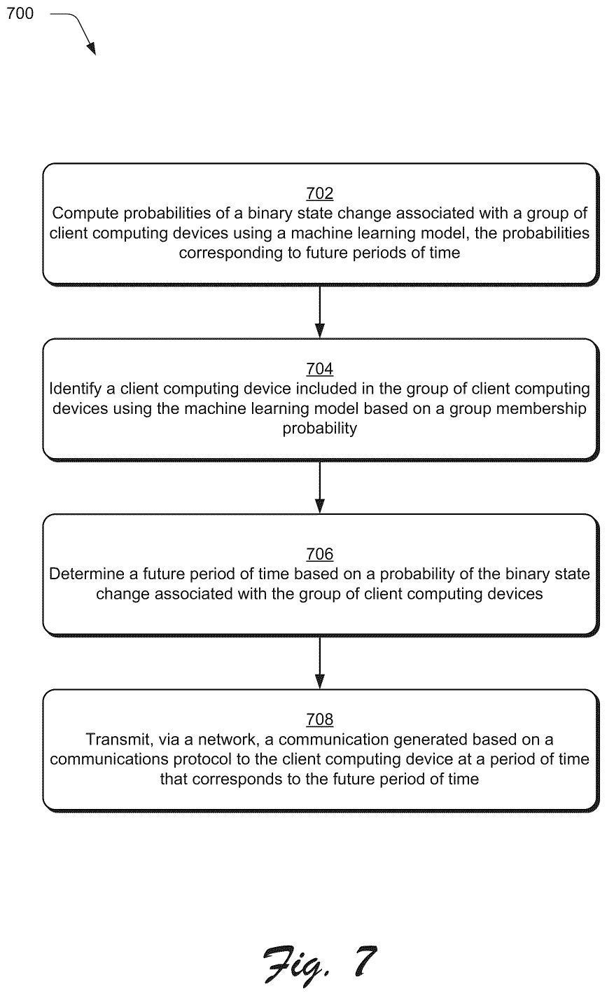

FIG. 7 is a flow diagram depicting a procedure 700 in an example implementation in which a future period of time is determined based on a probability of a binary state change associated with a group of client computing devices, and a communication is transmitted to a client computing device at a period of time that corresponds to the future period of time. Probabilities of a binary state change associated with a group of client computing devices are computed using a machine learning model, the probabilities correspond to future periods of time (block 702). For example, the computing device 102 implements the occurrence module 110 to compute the probabilities using the Bayesian mixture multi-armed bandit model. In this example, the occurrence module 110 computes the probabilities using the first machine learning model 402.

A client computing device included in the group of client computing devices is identified using the machine learning model based on a group membership probability (block 704). In one example, the occurrence module 110 identifies the client computing device based on the group membership probability. A future period of time is determined based on a probability of the binary state change associated with the group of client computing devices (block 706). In some examples, the computing device 102 implements the occurrence module 110 to determine the future period of time. A communication generated based on a communications protocol is transmitted, via a network, to the client computing device at a period of time that corresponds to the future period of time (block 708). For example, the occurrence module 110 transmits the communication to the client computing device at the period of time that corresponds to the future period of time.

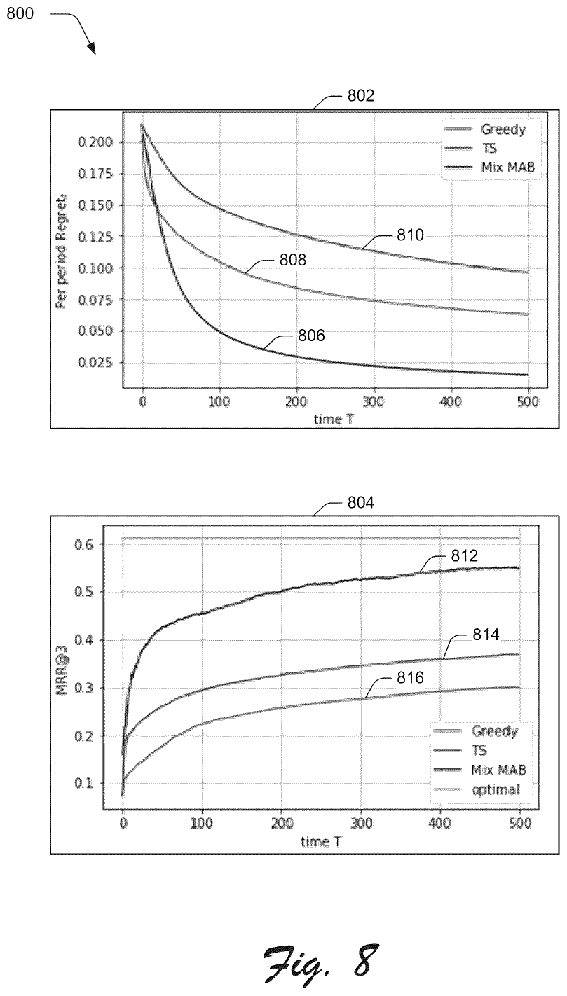

FIG. 8 illustrates a representation 800 of improvements of systems for estimating temporal occurrence of a binary state change relative to conventional systems. The representation 800 includes comparisons of per period regret in a first example 802 and comparisons of top 3 mean reciprocal rank (MRR@3) in a second example 804 for estimated temporal occurrences of binary state changes using the described systems, an Epsilon Greedy algorithm, and Thompson sampling. A dataset used for the compassions includes 500 client computing devices that belong to four different groups. In an example, the described systems used the first machine learning model 402 for the comparisons.

The first example 802 includes indications of per period regret for estimates computed using the described systems 806, estimates computed using the Epsilon Greedy algorithm 808, and estimates computed using Thompson sampling 810. As shown, the per period regret for the estimates computed using the described systems 806 is lower than the per period regret for the estimates computed using the Epsilon Greedy algorithm 808 which is lower than the per period regret for the estimates computed using Thompson sampling 810. The second example 804 includes indications of MRR@3 for the estimates computed using the described systems 812, the estimates computing using Thompson sampling 814, and the estimates computed using the Epsilon Greedy algorithm 816. As indicated, MRR@3 for the estimates computed using the described systems 812 is higher than MRR@3 for the estimates computed using Thompson sampling 814 which is higher than MRR@3 for the estimates computed using the Epsilon Greedy algorithm 816.

### Example System and Device

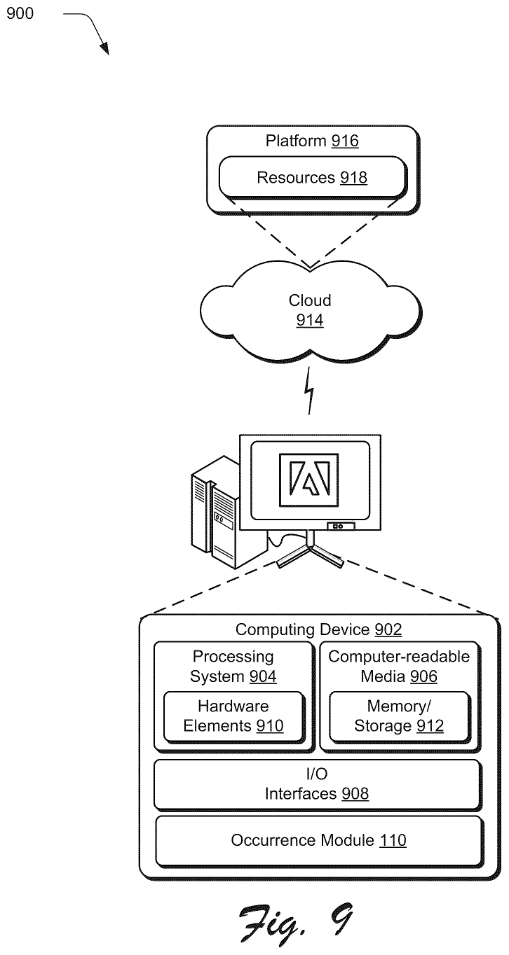

FIG. 9 illustrates an example system 900 that includes an example computing device that is representative of one or more computing systems and/or devices that are usable to implement the various techniques described herein. This is illustrated through inclusion of the occurrence module 110. The computing device 902 includes, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that are configured as processors, functional blocks, and so forth. This includes example implementations in hardware as an application specific integrated circuit or other logic device formed using one or more semiconductors. The hardware elements 910 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 906 is illustrated as including memory/storage 912. The memory/storage 912 represents memory/storage capacity associated with one or more computer-readable media. In one example, the memory/storage 912 includes volatile media (such as random access memory (RAM)) and/or nonvolatile media (such as read only memory (ROM), Flash memory, optical disks, magnetic disks, and so forth). In another example, the memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 910. For example, the computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supportable by various configurations of the computing device 902 and are not limited to the specific examples of the techniques described herein. This functionality is also implementable entirely or partially through use of a distributed system, such as over a “cloud” 914 as described below.

The cloud 914 includes and/or is representative of a platform 916 for resources 918. The platform 916 abstracts underlying functionality of hardware (e.g., servers) and software resources of the cloud 914. For example, the resources 918 include applications and/or data that are utilized while computer processing is executed on servers that are remote from the computing device 902. In some examples, the resources 918 also include services provided over the Internet and/or through a subscriber network, such as a cellular or Wi-Fi network.

The platform 916 abstracts the resources 918 and functions to connect the computing device 902 with other computing devices. In some examples, the platform 916 also serves to abstract scaling of resources to provide a corresponding level of scale to encountered demand for the resources that are implemented via the platform. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
computing, by a processing device using a machine learning model, a posterior probability distribution for temporal occurrences of binary state changes associated with client computing devices included in a group of client computing devices;
determining, by the processing device using the machine learning model, probabilities of a binary state change associated with a client computing device included in the group of client computing devices based on the posterior probability distribution, the probabilities corresponding to future periods of time;
identifying, by the processing device, a future period of time based on a probability of the binary state change associated with the client computing device; and
generating, by the processing device, a communication based on a communications protocol for transmission to the client computing device via a network at a period of time that corresponds to the future period of time.

2. The method as described in claim 1, wherein the machine learning model uses Bayesian Model-Agnostic Meta-Learning.

3. The method as described in claim 2, wherein the machine learning model is trained on training data describing historic temporal occurrences of the binary state changes.

4. The method as described in claim 2, wherein the machine learning model is trained on a training objective based on a conditional log-likelihood and a prior distribution.

5. The method as described in claim 1, wherein a temporal decaying factor is applied to the probabilities of the binary state change.

6. The method as described in claim 1, wherein the future periods of time are hours of a day.

7. The method as described in claim 1, wherein the probabilities of the binary state change are determined using Stein Variational Gradient Descent.

8. A system comprising:
a memory component; and
a processing device coupled to the memory component, the processing device to perform operations comprising:
computing probabilities of a binary state change associated with a group of client computing devices using a machine learning model, the probabilities corresponding to future periods of time;
identifying a client computing device included in the group of client computing devices using the machine learning model based on a group membership probability;
determining a future period of time based on a probability of the binary state change associated with the group of client computing devices; and
transmitting, via a network, a communication generated based on a communications protocol to the client computing device at a period of time that corresponds to the future period of time.

9. The system as described in claim 8, wherein the probabilities are computed using an expectation-maximization algorithm.

10. The system as described in claim 8, wherein the future periods of time are hours of a day.

11. The system as described in claim 8, wherein the machine learning model includes a Bayesian mixture multi-armed bandit model.

12. The system as described in claim 8, wherein a mixture distribution of the machine learning model defines the group of client computing devices.

13. The system as described in claim 8, wherein the machine learning model is trained on a training objective based on a conditional log-likelihood and a prior distribution.

14. A non-transitory computer-readable storage medium storing executable instructions, which when executed by a processing device, cause the processing device to perform operations comprising:
computing a posterior probability distribution for temporal occurrences of binary state changes associated with client computing devices included in a group of client computing devices using a machine learning model;
determining probabilities of a binary state change associated with a client computing device included in the group of client computing devices using the machine learning model based on the posterior probability distribution, the probabilities corresponding to future periods of time;
identifying a future period of time based on a probability of the binary state change associated with the client computing device; and
generating a communication based on a communications protocol for transmission to the client computing device via a network at a period of time that corresponds to the future period of time.

15. The non-transitory computer-readable storage medium as described in claim 14, wherein the machine learning model uses Bayesian Model-Agnostic Meta-Learning.

16. The non-transitory computer-readable storage medium as described in claim 15, wherein the machine learning model is trained on training data describing historic temporal occurrences of the binary state changes.

17. The non-transitory computer-readable storage medium as described in claim 15, wherein the machine learning model is trained on a training objective based on a conditional log-likelihood and a prior distribution.

18. The non-transitory computer-readable storage medium as described in claim 14, wherein a temporal decaying factor is applied to the probabilities of the binary state change.

19. The non-transitory computer-readable storage medium as described in claim 14, wherein the binary state change is a Bernoulli event with a constant success rate.

20. The non-transitory computer-readable storage medium as described in claim 14, wherein the probabilities of the binary state change are determined using Stein Variational Gradient Descent.
